(19) United States
(12) Patent Application Publication
(10) Pub. No.: US 2025/0199480 A1
(43) Pub. Date: Jun. 19, 2025

(54) PRODUCTION OF A TIMEPIECE WATERPROOF JOINT

(71) Applicant: The Swatch Group Research and Development Ltd, Marin (CH)

(72) Inventors: Marek DOVCIK, Mougins (FR); Nicolas FRANÇOIS, Neuchatel (CH); Sophie NAPOLI, Neuchatel (CH)

(73) Assignee: The Swatch Group Research and Development Ltd, Marin (CH)

(21) Appl. No.: 18/915,692

(22) Filed: Oct. 15, 2024

(30) Foreign Application Priority Data
Dec. 15, 2023 (EP) 23217082.9

(51) Int. Cl. G04B 37/08; B33Y 10/00; B33Y 80/00; G04D 3/00

(52) U.S. Cl. CPC G04B 37/08; B33Y 10/00; B33Y 80/00; G04D 3/0097

(57) ABSTRACT

A method for producing a timepiece component, a first part whereof includes a toleranced first reference surface, whereby, in a first step, a first material is chosen to produce this first part by additive manufacturing, and a base is prepared; in a second step, a base surface is etched in the base, which base surface is the negative of the first reference surface, and the base is positioned on an additive manufacturing means; in a third step, the first part of the component is grown by additive manufacturing in contact with the whole of the base surface; in a fourth step, the development of the first part is verified against a predetermined setpoint value, and the third additive manufacturing step is repeated iteratively until the desired level of development has been reached.

### TECHNICAL FIELD OF THE INVENTION

The invention relates to a method for producing a timepiece component by additive manufacturing, which timepiece component comprises at least a first part comprising a first reference surface with a first geometry toleranced in terms of dimension and/or flatness and/or cylindricity and/or surface finish.

The invention relates to the water-resistance of timepiece components and sub-assemblies, and more particularly to the manufacture of timepiece waterproof joints.

### TECHNOLOGICAL BACKGROUND

Waterproof joints, and in particular thermoplastic seals for the watchmaking industry, are nowadays produced by injection moulding or extrusion followed by machining or another method requiring a machining step. These seals must meet very strict tolerance criteria. These seals can be found on crystals, driven in backs, crowns and other elements of timepieces, particularly of watches, that must be resistant to water or have good adhesion.

Novel approaches such as additive manufacturing or 3D printing allow for the production of original designs and new types of assembly, including water-resistant seals. However, it is very difficult to meet the precision criteria for these seals, particularly in terms of the tolerances. The most critical dimension is the thickness of the seal.

### SUMMARY OF THE INVENTION

The aim of the invention is to develop a method for guaranteeing the strict tolerances, in terms of both dimensions and surface finish, of timepiece waterproof joints, while allowing small series production without having to invest in expensive tooling.

To this end, the invention relates to a method for producing a timepiece component by additive manufacturing, which timepiece component comprises at least a first part comprising a first reference surface with a first geometry toleranced in terms of dimension and/or flatness and/or cylindricity and/or surface finish.

According to the invention, in a first step, at least one first material is provided, which material is suitable for producing at least said first part of said component by additive manufacturing, and a base is provided, which base is suitable for supporting the growth of said first material and which is produced from a base material which is chosen to allow subsequent separation of said first part and said base without tearing; in a second step, said base is machined, in which a first base surface, which is the negative of said first reference surface, is etched with a base geometry compliant with tolerances equal to or stricter than those of said first geometry of said first reference surface, respectively in terms of dimension and/or flatness and/or cylindricity and/or surface finish, and the base is positioned on an additive manufacturing means; in a third step, at least said first part of said component is grown by additive manufacturing in contact with the whole of said first base surface; in a fourth step, the development of said first part is verified against a first predetermined setpoint value, and said third step of additive manufacturing with the addition of said first material and said fourth step are repeated iteratively until said first part is seen and confirmed to have developed to reach or exceed said first predetermined setpoint value, and additive manufacturing with the addition of said first material is stopped when said first part has developed to reach or exceed said first predetermined setpoint value.

### BRIEF DESCRIPTION OF THE FIGURES

The purposes, advantages and features of the invention will be better understood upon reading the following detailed description given with reference to the accompanying drawings, in which:

FIG. 1 is a flow chart illustrating the various steps in the production of a timepiece component according to the invention, in the various alternative embodiments of this method;

FIG. 2 diagrammatically shows a sectional view of a base in which a first base surface is etched using the method of the invention, with tolerances that are stricter than those of the component to be obtained, and its filling with a first raised portion made of a first material deposited by additive manufacturing, in particular by three-dimensional printing, in the etching of this first base surface;

FIG. 3 shows, similarly to FIG. 2, the component produced according to FIG. 2, after it has been extracted from the base;

FIG. 4 shows, similarly to FIG. 2, an alternative embodiment in which a first raised portion made of a first material and a second raised portion made of a second material are grown successively in the etching in the first base surface, and wherein this second raised portion is positioned above an upper surface of the base;

FIG. 5 shows, similarly to FIG. 4, the grinding of the second raised portion at the upper surface of the base;

FIG. 6 shows, similarly to FIG. 3, the component produced according to FIG. 5, after it has been extracted from the base;

FIG. 7 shows, similarly to FIG. 4, an alternative embodiment in which a first raised portion made of a first material and a second raised portion made of a second material are grown successively in the etching in the first base surface, and wherein a third raised portion made of another second material is also grown, this third raised portion forming a rigid structural part of the component;

FIG. 8 shows, similarly to FIG. 6, the component produced according to FIG. 7, after it has been extracted from the base.

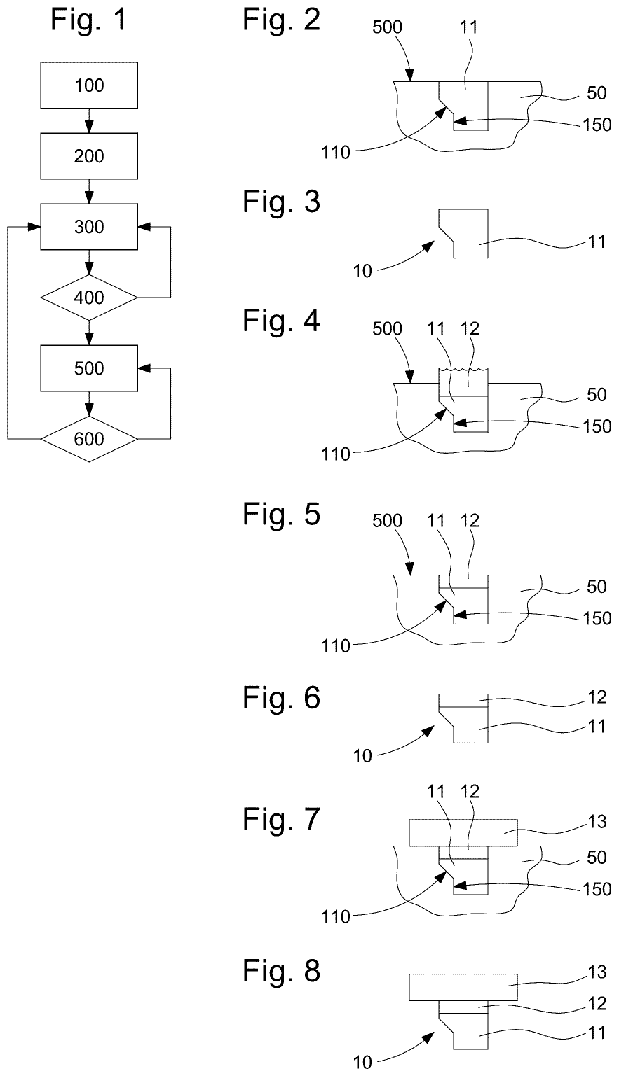

### DETAILED DESCRIPTION OF THE INVENTION

In order to overcome the poor quality of waterproof joints, particularly thermoplastic seals, the invention proposes improvements to the additive manufacturing process, which becomes more suitable for meeting the quality criteria of thermoplastic watch seals, in particular, compared with a manufacturing method that uses three-dimensional printing on a support, which does not always allow all of the dimensional and surface finish tolerances to be met.

Firstly, according to the invention, a bespoke print bed mat is produced for each joint geometry. Such a mat will contain an etching of the lower part of the seal to be produced. The etching is made by a laser or using an equivalent method.

Subsequently, this etching is filled in by additive manufacturing, including but not limited to three-dimensional printing, to obtain a precise shape with a quality comparable to that of injected seals. This allows the lower part of the seal to be truly reproduced. The upper part can be produced using a standard print quality. This part can represent the other half of the seal, as well as another watchmaking component that will be directly secured with the least precise part of the seal, without compromising water-resistance.

A person skilled in the art will thus be able to produce very precise seals using three-dimensional printing. Moreover, such seals can also form a direct part of another made-to-measure timepiece component.

Three-dimensional printing can be carried out using an appropriate printer with a custom levelling option. Depending on the complexity/depth of the etching, the printer nozzle can be modified and adapted for optimum printing.

The invention thus relates to a method for producing a timepiece component 10 by additive manufacturing, which component comprises at least a first part 11. This first part comprises a first reference surface 110 with a first geometry toleranced in terms of dimension and/or flatness and/or cylindricity and/or surface finish.

According to the invention, in a first step 100, at least one first material is provided, which material is suitable for producing at least the first part 11 of the component 10 by additive manufacturing.

A base 50 capable of supporting the growth of the first material is also provided. This base 5 is made from a base material chosen to allow subsequent separation of the first part 11 and the base 50 without tearing.

In a second step 200, the base 50 is machined, during which a first base surface 150, which is the negative of the first reference surface 110, is etched with a base geometry compliant with tolerances equal to or stricter than those of the first geometry of the first reference surface 110, respectively in terms of dimension and/or flatness and/or cylindricity and/or surface finish.

The base 50 is positioned on an additive manufacturing means, in particular a three-dimensional printing means.

In a third step 300, at least the first part 11 of the component 10 in contact with the entire first base surface 150 is grown by additive manufacturing.

In a fourth step 400, the development of the first part 11 is verified against a first predetermined setpoint value, and the third step 300 of additive manufacturing with the addition of the first material and the fourth step 400 are repeated iteratively until the first part 11 is seen and confirmed to have developed to reach or exceed the first predetermined setpoint value, and additive manufacturing with the addition of the first material is stopped when the first part 11 has developed to reach or exceed the first predetermined setpoint value.

More particularly, after the additive manufacturing of the first part 11 with the addition of the first material has been stopped when the first part 11 has developed to reach or exceed the first predetermined setpoint value, the first part 11 is separated from the base 50.

More particularly, after the additive manufacturing of the first part 11 with the addition of the first material has been stopped when the first part 11 has developed to reach or exceed the first predetermined setpoint value, the first part 11 is ground at an upper surface 500 comprised in the base 50.

More particularly, after stopping the additive manufacturing of the first part 11 with the addition of the first material when the first part 11 has developed to reach or exceed the first predetermined setpoint value, in a fifth step 500, additive manufacturing of the component 10 is continued by adding the first material and/or at least one second material, in order to produce the entire component 10; in a sixth step 600, the development of the component 10 is verified against a second predetermined setpoint value, and the fifth step 500 of additive manufacturing with the addition of the first material and/or of the at least one second material and the sixth step 600 are repeated iteratively until the component 10 is seen and confirmed to have developed to reach or exceed the second predetermined setpoint value, and additive manufacturing with the addition of the first material and/or of the at least one second material is stopped when the component 10 has developed to reach or exceed the second predetermined setpoint value.

More particularly, after additive manufacturing of the component 10 with the addition of the first material and/or of the at least one second material has been stopped when the component 10 has developed to reach or exceed the second predetermined setpoint value, the component 10 is separated from the base 50.

More particularly, the component 10 is produced by additive manufacturing with the addition of at least one second material, the material chosen for the second material being different from the first material.

More particularly, the component 10 is produced by additive manufacturing with the addition of at least one second material to the first part 11.

More particularly, the material chosen for the first material is capable of forming the first part 11 forming a first waterproof joint.

More particularly, the component 10 is produced by additive manufacturing with the addition of at least one second material, and the material chosen for the second material is capable of forming a second part 12 of the component 10, the second part 12 forming a second waterproof joint.

More particularly, the material chosen for the second material is capable of forming a second raised portion 20 constituting the second waterproof joint with resistance properties complementary to those of the first waterproof joint.

More particularly, the component 10 is produced by additive manufacturing with the addition of at least one second material, and elastomer materials are chosen for the first material and the second material, which materials have different Shore hardnesses in the respective final state of the first part 11 and of the remainder of the component 10 after the additive manufacturing operations with the addition of the first material and the second material respectively.

More particularly, the component 10 is produced by additive manufacturing with the addition of at least one second material, and the material chosen for at least the second material is capable of forming an optical contrast with the first material.

More particularly, the material chosen for at least the first material is capable of forming a first raised portion that is fluorescent or phosphorescent.

More particularly, the component 10 is produced by additive manufacturing with the addition of at least one second material, and the material chosen for at least the second material is capable of forming a second raised portion that is transparent and/or coloured.

More particularly, additive manufacturing is carried out by three-dimensional printing.

More particularly, the component 10 is produced to be used as a waterproof joint.

1. A method for producing a timepiece component by additive manufacturing, which timepiece component comprises at least a first part comprising a first reference surface with a first geometry toleranced in terms of dimension and/or flatness and/or cylindricity and/or surface finish, whereby, in a first step, at least one first material is provided, which material is suitable for producing at least said first part of said component by additive manufacturing, and a base is provided, which base is suitable for supporting the growth of said first material and which is produced from a base material which is chosen to allow subsequent separation of said first part and said base without tearing; in a second step, said base is machined, in which a first base surface, which is the negative of said first reference surface, is etched with a base geometry compliant with tolerances equal to or stricter than those of said first geometry of said first reference surface, respectively in terms of dimension and/or flatness and/or cylindricity and/or surface finish, and the base is positioned on an additive manufacturing means; in a third step, at least said first part of said component is grown by additive manufacturing in contact with the whole of said first base surface; in a fourth step, the development of said first part is verified against a first predetermined setpoint value, and said third step of additive manufacturing with the addition of said first material and said fourth step are repeated iteratively until said first part is seen and confirmed to have developed to reach or exceed said first predetermined setpoint value, and additive manufacturing with the addition of said first material is stopped when said first part has developed to reach or exceed said first predetermined setpoint value.
wherein, after the additive manufacturing of said first part with the addition of said first material has been stopped when said first part has developed to

[symbol]

2. The production method according to claim 1, reach or exceed said first predetermined setpoint value, said first part is separated from said base.

3. The production method according to claim 1, wherein, after the additive manufacturing of said first part with the addition of said first material has been stopped when said first part has developed to reach or exceed said first predetermined setpoint value, said first part is ground at an upper surface comprised in said base.

4. The production method according to claim 1, wherein, after stopping the additive manufacturing of said first part with the addition of said first material when said first part has developed to reach or exceed said first predetermined setpoint value, in a fifth step, additive manufacturing of said component is continued by adding said first material and/or at least one second material, in order to produce the entire component; in a sixth step, the development of said component is verified against a second predetermined setpoint value, and said fifth step of additive manufacturing with the addition of said first material and/or of said at least one second material and said sixth step are repeated iteratively until said component is seen and confirmed to have developed to reach or exceed said second predetermined setpoint value, and additive manufacturing with the addition of said first material and/or of said at least one second material is stopped when said component has developed to reach or exceed said second predetermined setpoint value.
wherein, after additive manufacturing of said component with the addition of said first material and/or of said at least one second material has been stopped when said component has developed to reach or exceed said second predetermined

[symbol]

5. The production method according to claim 4, setpoint value, said component is separated from said base.

6. The production method according to claim 4, wherein said component is produced by additive manufacturing with the addition of at least one second material, the material chosen for the second material being different from said first material.

7. The production method according to claim 6, wherein said component is produced by additive manufacturing with the addition of at least one second material to said first part.

8. The production method according to claim 1, wherein the material chosen for said first material is capable of forming said first part forming a first waterproof joint.

9. The production method according to claim 4, wherein said component is produced by additive manufacturing with the addition of at least one second material, and wherein the material chosen for said second material is capable of forming a second part of said component, said second part forming a second waterproof joint.

10. The production method according to claim 8, wherein said component is produced by additive manufacturing with the addition of at least one second material,
wherein the material chosen for said second material is capable of forming a second part of said component, said second part forming a second waterproof joint, and
wherein the material chosen for said second material is capable of forming said second part forming said second waterproof joint with resistance properties complementary to those of said first waterproof joint.

11. The production method according to claim 4, wherein said component is produced by additive manufacturing with the addition of at least one second material, and wherein the elastomer materials are chosen for said first material and said second material, which materials have different Shore hardnesses in the respective final state of said first part and of the remainder of said component after the additive manufacturing operations with the addition of said first material and said second material respectively.

12. The production method according to claim 4, wherein said component is produced by additive manufacturing with the addition of at least one second material, and wherein the material chosen for said second material is capable of forming a rigid structural part of said component.

13. The production method according to claim 4, wherein said component is produced by additive manufacturing with the addition of at least one second material, and wherein the material chosen for at least said second material is capable of forming an optical contrast with said first material.

14. The production method according to claim 1, wherein the material chosen for at least said first material is capable of forming a first raised portion that is fluorescent or phosphorescent.

15. The production method according to claim 4, wherein said component is produced by additive manufacturing with the addition of at least one second material, and wherein the material chosen for at least said second material is capable of forming a second raised portion that is transparent and/or coloured.

16. The production method according to claim 1, wherein said additive manufacturing is carried out by three-dimensional printing.

17. The production method according to claim 1, wherein said component is produced to be used as a waterproof joint.

18. A timepiece comprising a timepiece component obtained using the production method according to claim 1.

19. The timepiece according to claim 18, wherein said component is a waterproof joint.
